(19) United States
(12) Patent Application Publication
(10) Pub. No.: US 2005/0153814 A1
(43) Pub. Date: Jul. 14, 2005

(54) Torque equalisation in toric transmissions

(76) Inventor: Forbes G. Perry, Charlbury (GB)

Correspondence Address: NIXON & VANDERHYE, PC, 1100 N GLEBE ROAD, 8TH FLOOR, ARLINGTON, VA, 22201-4714, US

(21) Appl. No.: 11/019,641

(22) Filed: Dec. 23, 2004

(30) Foreign Application Priority Data
Dec. 23, 2003 (GB) 0329773.6

(51) Int. Cl. F16H 15/38

(52) U.S. Cl. 476/40; 476/46

(57) ABSTRACT

A toroidal race rolling traction transmission includes a sleeve which is rotatable to adjust the attitudes of at least one set of rollers and is displaceable in a sense substantially orthogonal to the sense of rotary adjustment. The displacement is damped to inhibit oscillation in the sense of displacement. Each means for damping comprises a chamber connected by way of a narrow orifice to a pressurized lubrication system. A non-return valve may be disposed in the this chamber. For equalisation of torque among the rollers in a set the sleeve receives an inner end of a respective control arm, and each inner end constitutes a piston in a respective damping chamber. The transmission preferably has two sets of rollers and the sleeve is obliquely connected to the control arms so that axial displacement of the sleeve is caused by the set producing the greater torque and produces rotary adjustment of the control arms of the other set to equalise the torques of the two sets.

### FIELD OF THE INVENTION

The present invention relates to toric transmissions, that is to say rolling traction transmissions wherein there is at least one set of rollers which engage each of two relatively rotatable toroidal raceways, the rollers of a set being conjointly adjustable in attitude relative to the raceways in order to vary the transmission ratio between the input and output raceway.

### BACKGROUND TO THE INVENTION

Some embodiments of such a transmission have a single set of rollers of which the carriers are linked by pivoted arms to a common rotatable adjuster or sleeve which, for example, is rotated by a control arm to change the transmission ratio. More complex embodiments have more than one set of rollers which are disposed between respective pairs of raceways. In embodiments such as these the sets of rollers are conjointly adjustable by means of a common rotatable adjuster or sleeve.

In order to promote maximum film traction in toric transmissions, it is highly desirable to equalise the torques taken by all the rollers. For a single-sided unit, the torques need to be equalised between the rollers in the set. For a double-sided unit, the torques needs to be equalised between the sets of rollers as well as between the rollers in each set.

### SUMMARY OF THE INVENTION

One way of achieving equalisation of torque among the rollers in a set is to allow radial freedom of the central rotatable sleeve. The sleeve accommodates one end of a linkage arm or rocker of which the other end is pivotally connected between the ends of adjacent rollers; radial displacement of the sleeve will alter slightly the angular relationship between the linkage arms and the arrangement of the linkage can be such that the radial displacement alters differently the angular attitudes of the rollers so that load is shed from those more highly loaded to those with less load.

However, such a transfer of torque tends to be unstable in that surplus torque from a roller can move the sleeve so as to pass the surplus around all the rollers of the set in a continuous adjustment that does not find a stable equilibrium. The radial movement needs to be damped and one object of the present invention is to provide a toric transmission which allows torque equalisation between the sets of a roller by allowing radial freedom of a common rotary adjuster while promoting the achievement of stable equilibrium by damping the radial movement.

Another aspect of the invention concerns, as indicated above, the connection of two sets of rollers for equalisation of torque between those sets as well as between the rollers of each set. Thus another aspect of the invention concerns the provision of a common rotary adjuster for the rollers in a double-sided set of rollers wherein the rotatable adjuster is obliquely slidably linked to the rocker arms of each set and is capable of damped axial displacement to allow equalisation of torque between the sets of rollers.

In each case the damping may be provided by means of at least one damping chamber which is connected to receive lubricating fluid under pressure from a central reservoir by way of a narrow orifice.

The nature of the invention and the manner in which it can be put into practice will be more fully explained in the following description with reference to the accompanying drawings.

### BRIEF DESCRIPTION OF THE DRAWINGS

FIG. 1 is a sectional view of a set of rollers and its control linkage.

FIG. 2 is a sectional view of an embodiment of a single-sided rolling traction transmission according to the invention.

FIG. 3 is a sectional view of a detail of the embodiment of FIG. 2.

FIG. 4 is a sectional view of another detail of the embodiment shown in FIG. 2.

FIG. 5 is a sectional view of one embodiment of a double-sided rolling traction transmission unit according to the invention.

FIG. 6 is a cross-sectional view of part of the embodiment shown in FIG. 5.

FIG. 7 is a cross-sectional expanded view of part of the embodiment shown in FIG. 5.

FIG. 8 is a sectional view showing an alternative for part of the embodiment shown in FIG. 5, and

FIG. 9 illustrates a different embodiment for part of the embodiment shown in FIG. 5.

### DETAILED DESCRIPTION

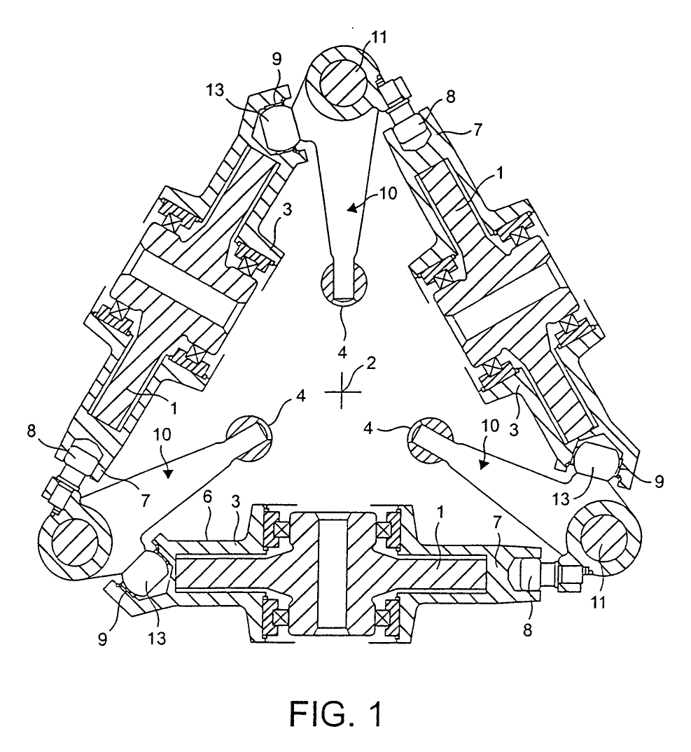

FIG. 1 of the drawings illustrates by way of example a set of rollers 1 which constitute part of a rolling traction toric transmission. The rollers 1 each engage two part toroidal raceways which are relatively rotatable. Typically one raceway is fixed to a main shaft whereas the other or output raceway is rotatable relative to that shaft but coaxially relative thereto.

Each of the rollers is disposed in a respective carrier 3. At one end of each of the carriers is a cylindrical socket 7 which accommodates a part spherical ball 8 connected to an arm or rocker 10 which is mounted on a shaft 11 integral with or secured to a fixed member such as a ‘spider’. The arm 10 extends towards the principal axis 2 of the toric transmission and its inner end carries a ball end 4 which may be part-spherical or cylindrical and which is held in a socket of a common rotatable adjuster, to be described with reference to FIG. 2.

At the end opposite the socket 7 each arm has an obliquely disposed bearing 9 which accommodates a ball 13 carried on an extension near the outer end of an adjacent one of the arms 10.

The purpose of the linkage in FIG. 1 is to convert a common rotary movement of the balls 4 about the axis 2 to the carriers 3 in order to alter conjointly the attitudes of the rollers 1 relative to the toric raceways and thereby to alter the transmission ratio. The linkage is by no means the only one which may be employed and is given merely as an example of a set of rollers which are conjointly adjustable by means of control arms or rockers extending from a common rotatable adjuster or sleeve.

FIG. 2 illustrates, in conjunction with FIG. 1, one embodiment of the invention. The rollers 1 engage a raceway constituted by a toroidal surface of an input disc 20 which is keyed to a central shaft 21 of the transmission unit. An output raceway is presented by a disc 22 which is rotatable relative to the input race 20 and for this purpose is mounted by means of roller bearings 23 on a peripheral surface of a fixed support or ‘spider’ 24.

For the peripheral adjustment of the balls 4 on the rocker arms 10, there is a rotary sleeve 25, which is connected to a rotary control arm 26 and has for each ball 4 a radial, cylindrical socket 27.

An example of the change of attitude of the rollers is shown by the lines 1a and 1b in the lower part of FIG. 2. The line 1a indicates the rollers' axes for the lowest forward transmission ratio whereas the line 1b indicates the rollers' axes for the highest forward transmission ratio; line Ic represents the axes of the rollers when the transmission ratio provided by the set is 1:1.

As indicated in the foregoing, to achieve the full capacity of film traction in a toric transmission it is desirable to equalise the torques taken by all the rollers in a set of rollers. In the embodiment shown in FIG. 2, transfer of torque between rollers is allowed by means of radial freedom of the central sleeve 25 which is rotated by control arm 26 to change the transmission ratio provided by the set of rollers 1. This radial freedom is substantially orthogonal to the rotary movement of the sleeve 25.

The sleeve 25 accepts the inner end of the control or rocker arms 10, the part spherical ball being accommodated by the respective cylindrical socket 27 of the control sleeve 25. Radial displacement of the sleeve will alter slightly the angular relationship between the rockers; this alteration will also change the angular attitudes of the rollers slightly and differently so that load is shed from a more highly loaded roller to one with less load.

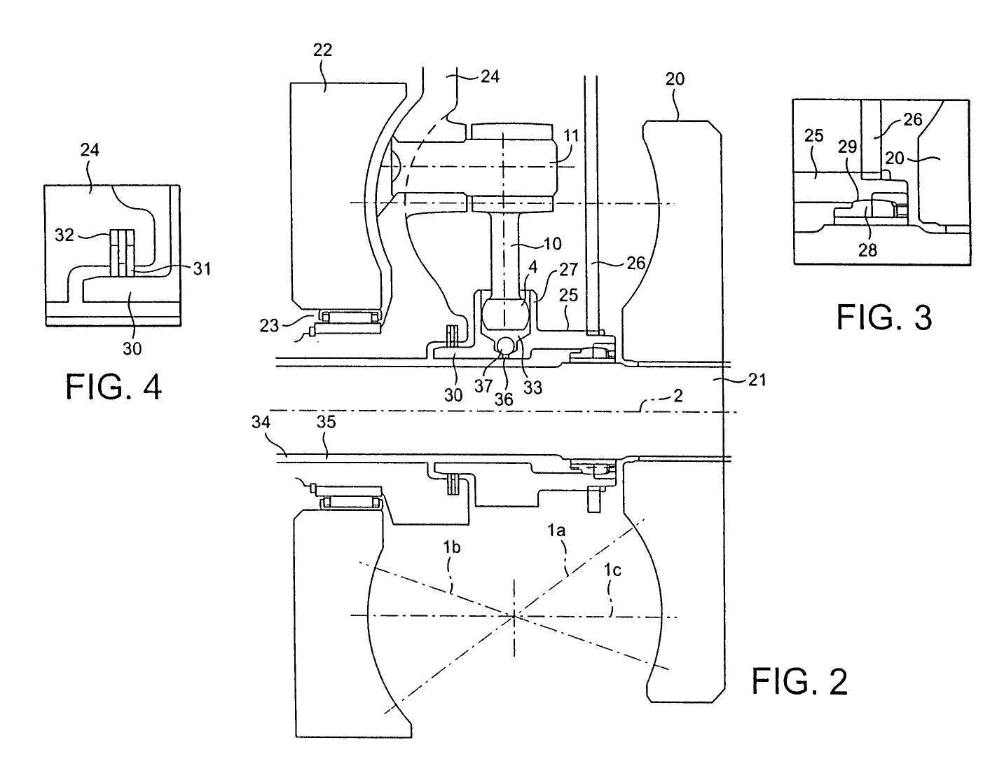

The radial freedom is provided in the embodiment shown in FIG. 2 by means of an annular convex bearing surface 28 engaged at one end of the control sleeve 25 by a correspondingly concave ring 29 supported by the main shaft 21, as shown in FIG. 3. At its other end the sleeve 25 has a flange 30 which carries a fluid seal comprising radially extending tongues 31 accommodated within a circumferential groove 32 in the spider 24. Thus the control sleeve 25 can pivot about one end by means of the curvature of member 28 and surface 29, while being rotatable relative to the fixed spider 24.

Theoretically there is an equilibrium position for the sleeve 25, the left-hand end of the sleeve being radially displaced relative to the axis 2, which is associated with equalisation of torque provided by the rollers 1. The particular radial direction depends on the distribution of the torques. However, the transfer of torque from one roller to another tends to be unstable in that surplus rocker torque from a roller can move the sleeve 25 so as to pass the surplus torque around all the rollers 1 in the set in a continuous adjustment that does not achieve stable equilibrium.

Accordingly, the invention provides damping of the permitted radial movement of the sleeve 25.

In order to damp the radial movement of the sleeve 25, the ball end 4 of each rocker arm 10 acts as a respective piston in a damping chamber constituted by the cylindrical cavity 27. A space 33 at the bottom of the damping chamber is connected to receive lubricating fluid, particularly oil, under pressure from a lubrication system 34 that provides oil under pressure to an annular space 35 between the main shaft 21 and the control sleeve 25. Oil will enter the space 33 by way of an orifice 36 which is provided with a non-return valve, in this embodiment constituted by a ball 37 which allows oil into the space 33 when the pressure in the lubrication system exceeds the pressure in the chamber 27 but closes the orifice 36 as the sleeve 25 moves outwardly in the relevant radial direction. The lubricating fluid can escape only slowly between the ball end 4 and the chamber 27. The restriction of the rapidity of movement of the sleeve will stabilise the linkage in a configuration which corresponds to equalisation of the torque among the rollers 1.

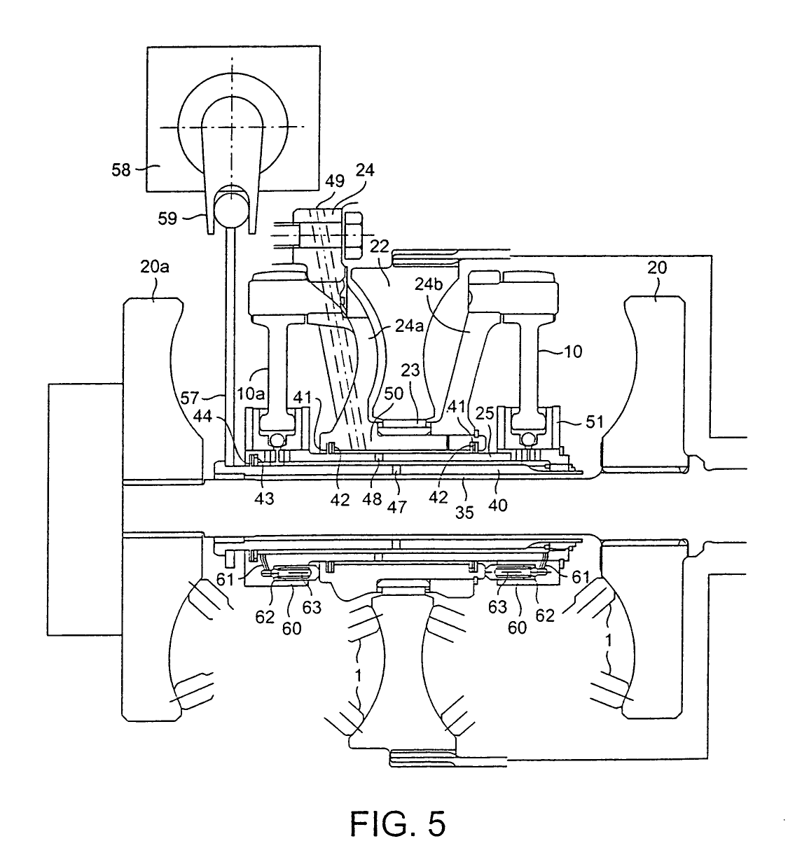

In a double-sided transmission the two sets of rollers need to be connected in some way for equalisation of the torque between the sets of rollers as well as between the rollers in each set. An embodiment of the invention which allows equalisation of torque in this manner will now be described with reference to FIG. 5.

In the embodiment of FIG. 5, there are two sets of rollers 1, a first set providing traction between an input disc 20 and one toroidal face of a disc 22. The other set of rollers provides traction between a second input disc 20a and the other face of disc 22. The main reaction member comprises two connected spiders 24a and 24b. The former has a radial flange 50 on which the spider 24b is mounted. The bearing 23 is carried on the outer periphery of the flange 50 and double-sided output disc 22 rotates by means of the bearing 23.

In this embodiment of the invention the adjuster is required to provide not only radial displacement to allow equalisation of torques within each set of rollers but also, as will be described, axial displacement of the rotary adjuster to enable equalisation of torques between the two sets of rollers. For this purpose the adjuster comprises two sleeves, one inside the other. The outer sleeve, denoted 25, has radial freedom and is torsionally connected to the inner sleeve 40. The outer sleeve 25 has a radial tongue fluid seal 41 accommodated in circumferential grooves 42 in the spiders 24a and 24b to allow radial and rotary movement of the sleeve relative to the spiders. The sleeve 40 has a tongue seal 43 accommodated in a circumferential groove in outer sleeve 25. The outer sleeve 25 is torsionally connected to the inner sleeve 40 by a spline integral with an adjoining part 51 (to be described).

Oil from the pressurized lubrication system (not shown) can enter the space between the sleeves 25 and 40 by way of lubricating hole 48 and the space between the sleeve 25 and the spiders by way of the main lubricating hole 49 in the spider. A hole 47 in the inner sleeve 40 provides a fluid flow to the face of disc 20.

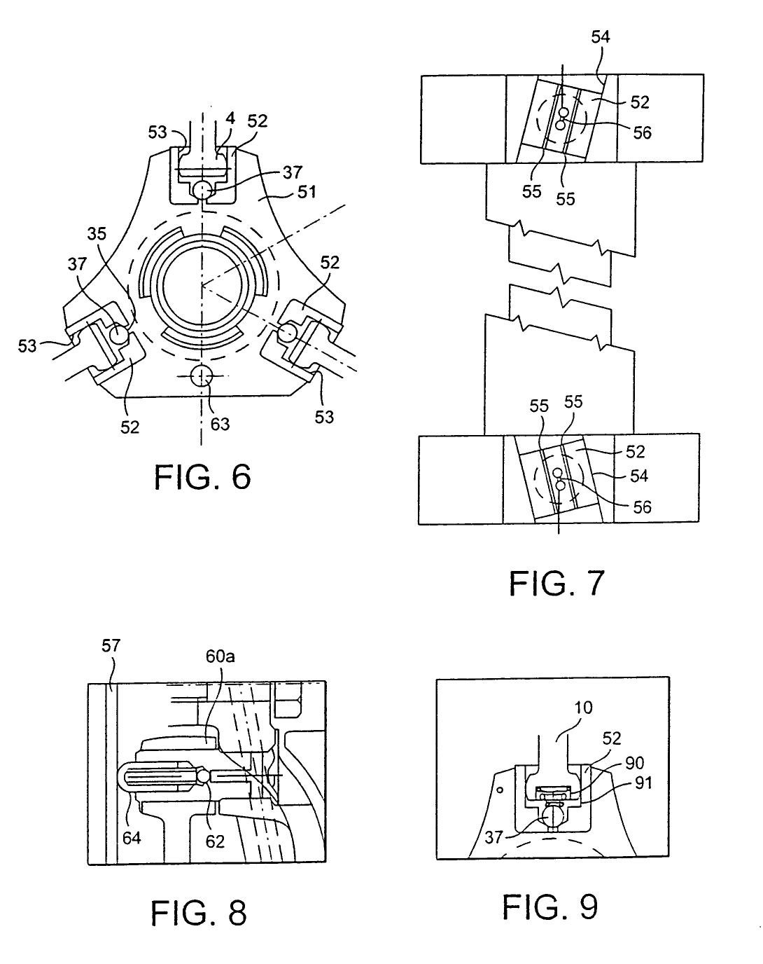

As is shown particularly in FIG. 6, the adjustment sleeve 25 has at each end a triangular part 51 which is integral with the sleeve 25 at the left-hand end and is carried partly on the sleeve 25 and partly on the sleeve 40 at the other end, so torsionally connecting the two sleeves but with sufficient clearances to permit limited angular adjustment. Each triangular part 51 accommodates three feet 52, each of which defines a cylindrical chamber 53 which receives a respective ball end 4 of a rocker arm 10. The chamber 53 has a narrow bottom orifice 35 closed by a non-return ball valve 37 as previously described with reference to FIG. 2.

The non-return valve need not be constituted by a ball valve as shown. One option is to employ a flap cut in a thin circular washer, for example made of shim steel (which may be between about 0.05 to 0.1 mm thick). In the event of back flow the flap can close over the corresponding aperture in the washer and cut off all flow completely. Another option is to omit the non-return valve and rely on the damping effect produced because the displaced fluid is restricted by a very small inlet orifice, typically 2 mm or so in diameter.

As is shown in FIG. 7 the feet 52 are located in oblique slots 54 in the axially moveable assembly of sleeves 25 and 40. The force on each foot produced by pressure in the cavity is made greater than that tending to lift each foot 52 off the part 51. Two pressure relief channels 55 are provided in the contact faces between each foot 52 and the part 51 so that the pressure and pressure gradients transferred from the central reservoir of the lubrication system to the foot cannot lift the foot out of its slot. Oil is transferred to the hole 25 by way of an oil feed slot, or as illustrated, two side-by-side holes 56 in the part 51.

To equalise the torque between sets, the slots 54 in the parts 51 are obliquely disposed so that the combined torques from the rockers 10 of one set produce an axial force which is balanced against the axial force from the other set. If the torques of the roller sets are not equal, the resulting out of balance axial forces moves sleeves 40 and 25 axially to change the roller angles of the sets relative to each other and thereby the torques they take. The inner sleeve 40 is connected to a control arm 57 coupled to a ratio control piston 58 by a ball joint which can accommodate the axial movement of the adjusting sleeves as well as providing the normal rotary adjustment of the sleeves.

Although the slot angles can be less than normal angles of friction, the sleeves 25 and 40 can still oscillate axially instead of attaining a stable position. To prevent this oscillation, one-way dampers 60 acting in the same manner as described before are made to bear against between each part 51 (or some part firmly attached to it) and some fixed part such as the main reaction member or spider. As is shown in FIG. 5, there is a damper 60 between each part 51 and the hub of the respective spider 24a and 24b. Each of the dampers has an inlet 61 connected to the main supply of pressurised lubricating fluid and comprises a non-return valve (a ball 62) and a piston 63 urged by the fluid pressure into contact with the hub of the adjacent spider.

Only one damper may be necessary since unidirectional action may eliminate the forward/backward cycle of operation. The unbalanced axial force from the use of only one damper is quite small.

FIG. 8 illustrates a possible alternative for the axial damper: a damper 60a resembling damper 60 is disposed in the spider pins of one or more rockers and has a piston 64 engaging the control arm 57.

FIG. 9 illustrates an alternative embodiment of a damper, shown for convenience in association with an arm 10. The ball end of the arm has a recess 90 retaining a helical compression spring 91 engaging the ball 37 against the orifice at the bottom of the damping chamber.

1. A toroidal race rolling traction transmission including:
at least one set of rollers which are conjointly adjustable to alter a transmission ratio;
a member which is rotatable to adjust the attitudes of said rollers;
wherein said member is capable of displacement in a sense substantially orthogonal to the sense of adjustment of said rollers; and
means for damping said displacement to inhibit oscillation in the sense of said displacement.

2. A transmission as in claim 1 wherein said member is disposed to receive an inner end of each of a plurality of control arms, said member being capable of radial displacement which by way of said control arms alters the attitudes of said rollers differently and provides equalisation of torque between said rollers.

3. A transmission as in claim 2 wherein said member is disposed to receive an inner end of each of said control arms and includes a plurality of damping chambers, said inner ends each constituting a piston in a respective one of said damping chambers.

4. A transmission as in claim 2 wherein the transmission has two sets of said rollers and said member has an axially displaceable part obliquely connected to said control arms so that the axial displacement of said member is caused by the set of rollers producing greater torque and produces rotary adjustment of the control arms of the other set of rollers to equalise the torques of the two sets of rollers.

5. A transmission as in claim 4 and further comprising a damper for damping axial displacement of said axially displaceable part.

6. A transmission as in claim 5 wherein said damper comprises a piston in a damping chamber, said piston being carried by said axially displaceable part.

7. A toroidal race rolling traction transmission including:
at least one set of rollers which are conjointly adjustable to alter a transmission ratio;
a member which is rotatable to adjust the attitudes of said rollers;
a plurality of control arms linked to said rollers;
wherein said member is disposed to receive an inner end of each of said control arms and capable of radial displacement which by way of said control arms alters the attitudes of said rollers differently and provides equalisation of torque between them;
wherein said member is capable of displacement in a sense substantially orthogonal to the sense of adjustment of said rollers; and
said member is disposed to receive an inner end of each of said control arms and includes a plurality of damping chambers, said inner ends each constituting a piston in a respective one of said damping chambers.

7. A transmission as in claim 6 wherein a pressurized lubrication system connected to each of said damping chambers by way of a respective narrow orifice.

8. A transmission as in claim 6 wherein each damping chamber includes a non-return inlet valve.

9. A transmission as in claim 6 wherein the transmission has two sets of said rollers and said member has an axially displaceable part obliquely connected to said control arms so that the axial displacement of said member is caused by the set of rollers producing greater torque and produces rotary adjustment of the control arms of the other set of rollers to equalise the torques of the two sets of rollers.

10. A transmission as ir claim 9 wherein said axially displaceable part carries a piston movable in a damping chamber.
